(19) United States
(12) Patent Application Publication
(10) Pub. No.: US 2021/0312436 A1
(43) Pub. Date: Oct. 7, 2021

(54) INFORMATION PROCESSING APPARATUS, INFORMATION PROCESSING PROGRAM, AND INFORMATION PROCESSING SYSTEM

(71) Applicant: TOYOTA JIDOSHA KABUSHIKI KAISHA, Toyota-shi (JP)

(72) Inventors: Kazuyuki INOUE, Nagoya-shi (JP); Kuniaki JINNAI, Nagoya-shi (JP); Kenichiro FUJIMORI, Tokyo (JP); Kohei TSUDA, Tokyo (JP); Noriaki MOCHIDA, Nagoya-shi (JP); Shuhei OCHIAI, Nagoya-shi (JP); Satoru SAKAMOTO, Tokyo (JP); Masashi KAMAKURA, Ichikawa-shi (JP)

(73) Assignee: TOYOTA JIDOSHA KABUSHIKI KAISHA, Toyota-shi (JP)

(21) Appl. No.: 17/205,543

(22) Filed: Mar. 18, 2021

(30) Foreign Application Priority Data
Apr. 6, 2020 (JP) 2020-068465

(51) Int. Cl. G06Q 20/38; G06Q 10/10

(52) U.S. Cl. CPC G06Q 20/389; G06Q 10/1093; G06Q 20/3821

(57) ABSTRACT

An information processing apparatus includes a processor having hardware. The processor is configured to create distribution information including a privilege according to an area contribution degree in a visit area at a first distance or more from a residential area of a user based on an activity history of the user and displays the distribution information on a user terminal of the user.

### CROSS-REFERENCE TO RELATED APPLICATION

This application claims priority to Japanese Patent Application No. 2020-068465 filed on Apr. 6, 2020, incorporated herein by reference in its entirety.

### BACKGROUND

### 1. Technical Field

The present disclosure relates to an information processing apparatus, an information processing program, and an information processing system.

### 2. Description of Related Art

Japanese Unexamined Patent Application Publication No. 2018-132826 (JP 2018-132826 A) and Japanese Unexamined Patent Application Publication No. 2018-81337 (JP 2018-81337 A) disclose a technique that issues a coupon to a user based on a purchase history or an affection degree for an area of the user.

### SUMMARY

Incidentally, other than local people who reside in an area, nonlocal people who reside in a different area visit the area and purchase articles or services of the visit area, leading to the revitalization of the area. In addition, nonlocal people repeatedly visit the area and purchase the articles or the services, leading to the further revitalization of the area.

The present disclosure has been accomplished in view of the above description, and provides an information processing apparatus, an information processing program, and an information processing system capable of supporting revitalization of an area.

A first aspect of the present disclosure relates to an information processing apparatus including a processor having hardware. The processor is configured to calculate an area contribution degree in a visit area at a first distance or more from a residential area of a user based on an activity history of the user, create distribution information including a privilege according to the area contribution degree, and display the distribution information on a user terminal of the user.

A second aspect of the present disclosure relates to an information processing program. The information processing program causes a processor having hardware to execute calculating an area contribution degree in a visit area at a first distance or more from a residential area of a user based on an activity history of the user, creating distribution information including a privilege according to the area contribution degree, and displaying the distribution information on a user terminal of the user.

A third aspect of the present disclosure relates to an information processing system including a terminal and an information processing apparatus. The terminal includes a first processor having hardware, and a display. The information processing apparatus includes a second processor having hardware. The second processor is configured to calculate an area contribution degree in a visit area at a first distance or more from a residential area of a user of the terminal based on an activity history of the user, create distribution information including a privilege according to the area contribution degree, and display the distribution information on the terminal.

According to the aspects of the present disclosure, it is possible to support revitalization of an area.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing the configuration of a wallet system according to an embodiment;

FIG. 2 is a block diagram schematically showing the configuration of a wallet server according to the embodiment;

FIG. 3 is a block diagram schematically showing the configuration of a settlement service provider server according to the embodiment;

FIG. 4 is a block diagram schematically showing the configuration of a user terminal according to the embodiment;

FIG. 5 is a diagram schematically showing a relationship of payment means, deposit means, and settlement means in the wallet system according to the embodiment;

FIG. 6 is a block diagram schematically showing the configuration of a vehicle according to the embodiment;

FIG. 7 is a flowchart illustrating distribution information creation processing that is executed by the wallet server according to the embodiment; and

FIG. 8 is a diagram showing an example where distribution information is displayed on an operation and display unit of the user terminal in the wallet system according to the embodiment.

### DETAILED DESCRIPTION OF EMBODIMENTS

Hereinafter, an embodiment of the present disclosure will be described referring to the drawings. In all drawings of the embodiment described below, the same or corresponding portions are represented by the same reference numerals. The present disclosure is not limited to the embodiment described below.

Wallet System

A wallet system according to the embodiment of the present disclosure to which an information processing apparatus can be applied will be described referring to the drawings. FIG. 1 is a diagram schematically showing the configuration of the wallet system according to the embodiment. As shown in FIG. 1, a wallet system 1 according to the embodiment has a wallet server 10, a settlement service provider server 20, a user terminal 30, a vehicle 40, and an area information management server 50 that can perform communication with one another through a network NW.

The network NW is constituted of an Internet network, a mobile phone network, or the like. The network NW is, for example, a public communication network, such as the Internet, and may include other communication networks, such as a wide area network (WAN), a telephone communication network of a mobile phone or the like, and a wireless communication network, such as WiFi (Registered Trademark).

Wallet Server

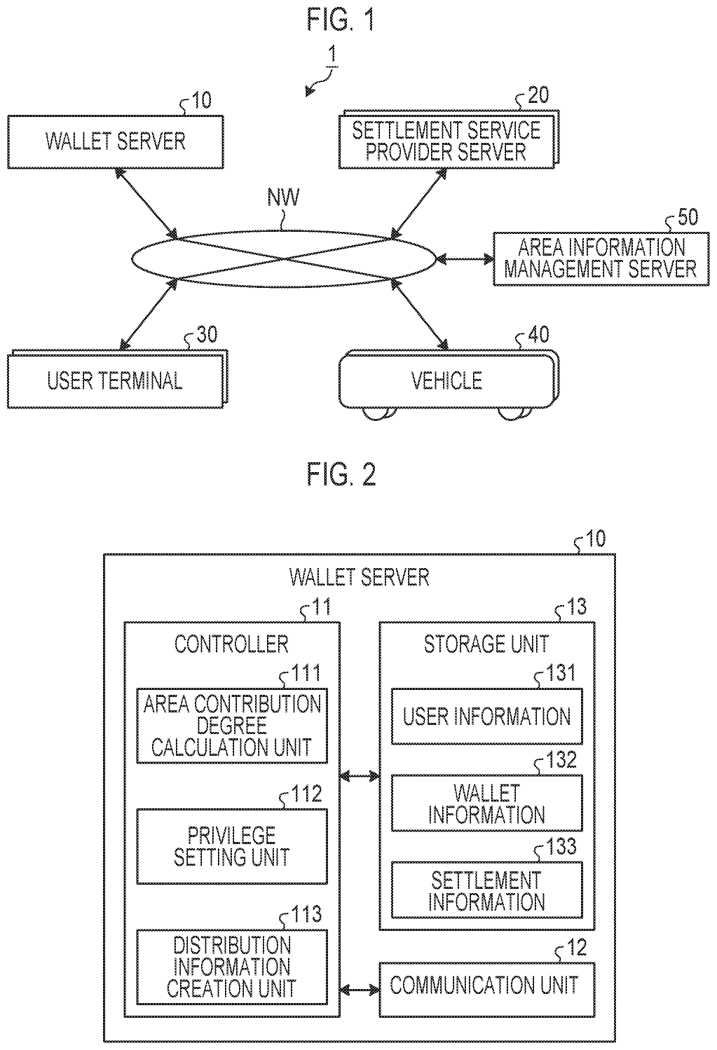

FIG. 2 is a block diagram schematically showing the configuration of the wallet server according to the embodiment. The wallet server 10 including an information processing apparatus is a server that integrally manages the wallet system according to the embodiment, and is managed by a manager of the wallet system. As shown in FIG. 2, the wallet server 10 includes a controller 11 as a second processor, a communication unit 12, and a storage unit 13.

The controller 11 specifically includes a processor having hardware, such as a central processing unit (CPU), a digital signal processor (DSP), or a field-programmable gate array (FPGA), and a main storage unit, such as a random access memory (RAM) or a read only memory (ROM). The storage unit 13 is constituted of a storage medium selected from an erasable programmable ROM (EPROM), a hard disk drive (HDD), and a removable medium. Examples of the removable medium include disc recording mediums, such as a universal serial bus (USB) memory, a compact disc (CD), a digital versatile disc (DVD), and Blu-ray disc (BD) (Registered Trademark). In the storage unit 13, an operating system (OS), various programs, various tables, various databases, and the like can be stored. The controller 11 loads programs stored in the storage unit 13 on a work area of the main storage unit and executes the programs, thereby controlling the components and the like through the execution of the programs. A program may be a learned model generated by, for example, machine learning, such as deep learning. With this, the controller 11 realizes functions of an area contribution degree calculation unit 111, a privilege setting unit 112, and a distribution information creation unit 113. Details of the functions of the area contribution degree calculation unit 111, the privilege setting unit 112, and the distribution information creation unit 113 will be described below.

The communication unit 12 is constituted of, for example, a local area network (LAN) interface board or a wireless communication circuit for wireless communication. The LAN interface board and the wireless communication circuit are connected to the network NW, such as the Internet that is a public communication network. The communication unit 12 is connected to the network NW to perform communication with the settlement service provider server 20, the user terminal 30, the vehicle 40, and the area information management server 50.

In the storage unit 13 according to the embodiment, user information 131, wallet information 132, and settlement information 133 for each user wallet system are stored. Furthermore, in the storage unit 13, a program for executing distribution information creation processing described below is also stored.

The user information 131 is information regarding a user who uses the wallet system. Examples of the user information 131 include a user ID of a user who performs use registration of the wallet system, a password, a name of the user, a place to contact of the user (for example, an address, a telephone number, and a mail address), a use registration history, information regarding payment means registered as deposit means, information regarding payment means registered as settlement means, a personal identification number at the time of settlement, and a movement history of the user by the vehicle 40. The user ID and the password in the user information 131 are used for authentication processing, such as login to the wallet server 10.

The wallet information 132 is information regarding a wallet of the wallet system. The wallet indicates a virtual deposit and withdrawal account of electronic money. Examples of the wallet information 132 include the user ID, a balance of electronic money, a deposit history of electronic money, and a use history of electronic money.

The settlement information 133 is information regarding settlement of the wallet system. Examples of the settlement information 133 include the user ID, settlement means (for example, electronic money payment (noncontact settlement), scan payment, code payment, or the like) used in settlement, and a settlement history.

Settlement Service Provider Server

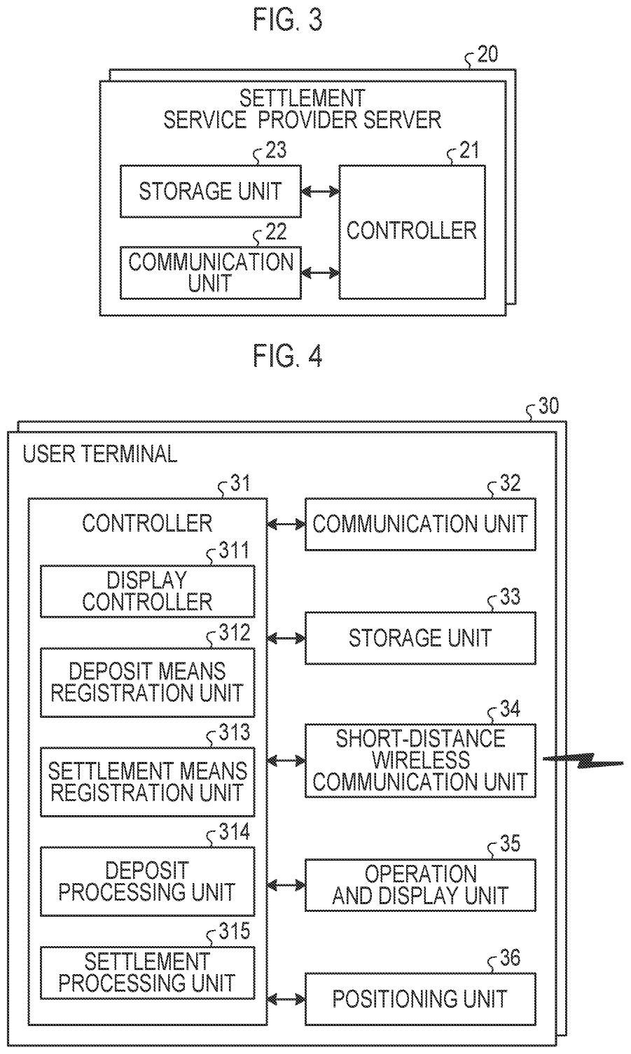

FIG. 3 is a block diagram schematically showing the configuration of the settlement service provider server according to the embodiment of the present disclosure. The settlement service provider server 20 is a server that manages an account and a credit card of the user, and is provided in a banking institution (for example, a bank, a credit union, a credit association, or a labor credit association) and a credit card company. As shown in FIG. 3, the settlement service provider server 20 includes a controller 21, a communication unit 22, and a storage unit 23. The controller 21, the communication unit 22, and the storage unit 23 are physically the same as the controller 11, the communication unit 12, and the storage unit 13, respectively.

In the storage unit 23, account information and credit card information for each user of the wallet system are stored. Examples of the account information include the name of the user, an account number, an account balance, and a deposit and withdrawal history. Examples of the credit card information include the name of the user, a credit card number, an expiration date of a credit card, a use limit amount, and a card use history.

User Terminal

FIG. 4 is a block diagram schematically showing the configuration of the user terminal according to the embodiment of the present disclosure. The user terminal 30 is a computer terminal that is used by the user. Examples of the user terminal 30 include a smartphone, a mobile phone, a tablet terminal, a wearable computer, or a personal computer, a car navigation device mounted in a vehicle, and the like that is owned by the user. The user terminal 30 may be any terminal as long as the terminal can exchange information with the wallet server 10.

As shown in FIG. 4, the user terminal 30 includes a controller 31 as a first processor, a communication unit 32, a storage unit 33, a short-distance wireless communication unit 34, an operation and display unit 35, such as a display, and a positioning unit 36. The controller 31, the communication unit 32, and the storage unit 33 are physically the same as the controller 11, the communication unit 12, and the storage unit 13, respectively. The controller 31 functions as the display controller 311, the deposit means registration unit 312, the settlement means registration unit 313, the deposit processing unit 314, and the settlement processing unit 315 through the execution of the programs.

The display controller 311 controls display contents on the operation and display unit 35. The display controller 311 displays, on the operation and display unit 35, a member registration screen when the user performs member registration, a login screen when the user logs in to the wallet system, a deposit screen when the user deposits electronic money in the wallet, a settlement screen when settlement is performed, a use history screen on which a list of use history, such as settlement, is displayed, a payment history detailed screen on which details of a payment history are displayed, a code payment screen, a scan payment screen, and the like based on a user's operation (touch operation, flick operation, or the like). The display controller 311 transits each screen based on a user's operation. The display controller 311 displays a display screen based on guidance information received from the wallet server 10. In regard to a screen configuration of the settlement screen, the use history screen, the payment history detailed screen, the code payment screen, and a guidance screen based on the guidance information, various configurations can be employed.

The deposit means registration unit 312 registers deposit means for depositing electronic money. Specifically, the deposit means registration unit 312 transmits a deposit means registration request for registering a plurality of different payment means (for example, bank account, credit card, virtual credit card, and the like) to be operated by a plurality of service providers as deposit means in the wallet to the wallet server 10. The controller 11 of the wallet server 10 that receives the deposit means registration request from the deposit means registration unit 312 registers the payment means included in the deposit means registration request as the deposit means by storing the payment means as the user information 131 in the storage unit 13.

The deposit means registration unit 312 also registers, as deposit means, payment means that is registered as settlement means. That is, when a settlement means registration request is transmitted from the settlement means registration unit 313 to the wallet server 10, the deposit means registration unit 312 transmits a deposit means registration request for registering payment means included in the settlement means registration request as settlement means to the wallet server 10. The controller 11 of the wallet server 10 that receives the deposit means registration request from the deposit means registration unit 312 registers the payment means included in the deposit means registration request as the deposit means by storing the payment means as the user information 131 in the storage unit 13.

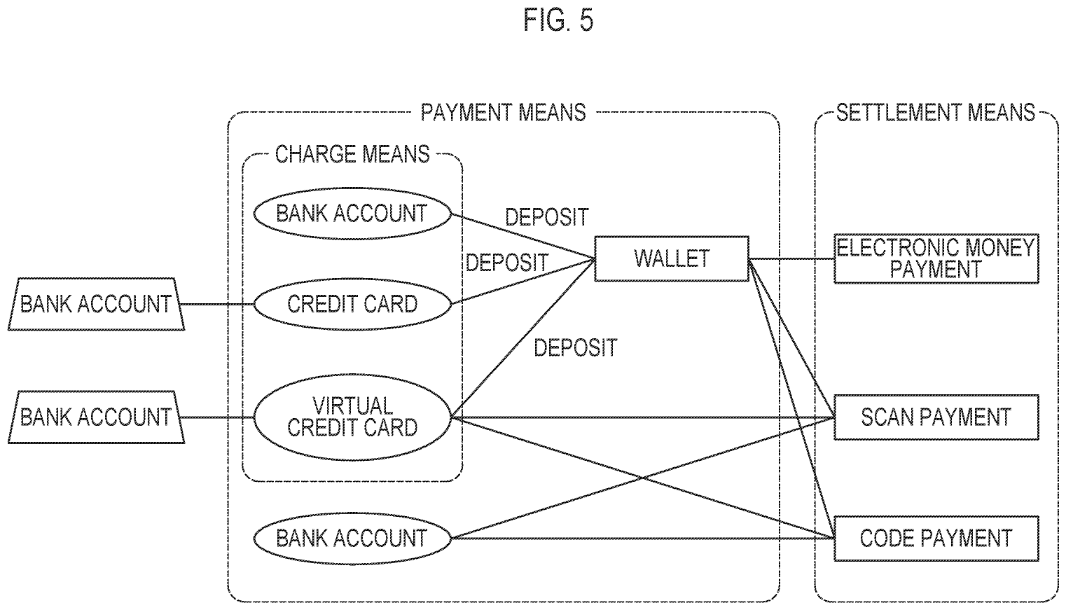

Here, FIG. 5 is a diagram schematically showing a relationship of payment means, charge means, and settlement means in the wallet system according to the embodiment. The “payment means” indicates means to be a payment resource (funding source) when settlement is performed. As the payment means, a bank account, a credit card, a virtual credit card, and a balance of electronic money in the wallet are included. The virtual credit card is an intangible credit card, and is constituted of, for example, information regarding a card number, an expiration date, and an authentication number (security code). A bank account is associated with each of the credit card and the virtual credit card, and a used amount of each card is withdrawn from the bank account later.

The “charge means” indicates means for depositing electronic money in the wallet that is a virtual deposit and withdrawal account. As the charge means, a bank account, a credit card, and a virtual credit card among the payment means are included. The bank account, the credit card, and the virtual credit card are registered as the charge means, whereby it is possible to deposit electronic money in the wallet.

The “settlement means” indicates a method that performs settlement using the payment means. The settlement means includes electronic money payment, scan payment, and code payment. The electronic money payment is, for example, settlement that is performed in a noncontact manner between the short-distance wireless communication unit 34 of the user terminal 30 and a short-distance wireless communication unit of a terminal in a store or the like by the user holding the user terminal 30 up to the terminal in the store or the like. The scan payment is settlement that is performed by reading a barcode or a QR code (Registered Trademark) displayed on the terminal in the store or the like with a camera or the like of the user terminal 30. The code payment is settlement that is performed by reading a barcode or a QR code (Registered Trademark) displayed on the user terminal 30 with a code reader or the like of the terminal in the store or the like.

In the wallet system according to the embodiment, it is possible to use all three kinds of settlement means using three kinds of payment means. That is, in the wallet system, it is possible to combine the payment means and the settlement means as (1) to (3) described below.

(1) The electronic money payment, the scan payment, and the code payment using the balance of electronic money in the wallet

(2) The electronic money payment, the scan payment, and the code payment using the virtual credit card

(3) The electronic money payment, the scan payment, and the code payment using the bank account

In this way, in the wallet system according to the embodiment, it is possible to deposit electronic money in the wallet through a plurality of payment means and to settle the balance of electronic money deposited in the wallet through a plurality of settlement means.

Returning to FIG. 4, the settlement means registration unit 313 also registers, as settlement means, the payment means that is registered as the deposit means. That is, when the deposit means registration request is transmitted from the deposit means registration unit 312 to the wallet server 10, the settlement means registration unit 313 transmits a settlement means registration request for registering the payment means included in the deposit means registration request as settlement means to the wallet server 10.

For example, when registering certain payment means (a bank account of an A bank) as deposit means, the settlement means registration unit 313 also automatically registers the payment means (the bank account of the A bank) as settlement means. “The payment means is registered as the settlement means” means that settlement can be performed using the payment means as a payment source, and means that the electronic money payment, the scan payment, and the code payment are enabled, for example, using the bank account of the A bank as a payment source. The controller 11 of the wallet server 10 that receives the settlement means registration request from the settlement means registration unit 313 registers the payment means included in the settlement means registration request as the settlement means by storing the payment means as the user information 131 in the storage unit 13.

The deposit processing unit 314 deposits electronic money in the wallet. Specifically, the deposit processing unit 314 transmits a deposit request for depositing electronic money in the wallet through the payment means registered as the deposit means to the wallet server 10. The controller 11 of the wallet server 10 that receives the deposit request from the deposit processing unit 314 increases the balance of electronic money in the wallet based on deposit amount information included in the deposit request. That is, the controller 11 updates the wallet information 132 stored in the storage unit 13 according to an increased amount of the balance of electronic money in the wallet.

The settlement processing unit 315 performs settlement with the payment means. The settlement processing unit 315 transmits a settlement request for performing settlement with electronic money deposited in the wallet using any one of a plurality of settlement means (electronic money payment, scan payment, and code payment) to the wallet server 10. For example, when performing the electronic money payment, the settlement processing unit 315 transmits the settlement request to the wallet server 10 through the network NW. When performing the scan payment, the settlement processing unit 315 transmits the settlement request to the wallet server 10 by reading a barcode or a QR code (Registered Trademark) displayed on the terminal in the store or the like with the camera or the like of the user terminal 30. When performing the code payment, the settlement processing unit 315 transmits the settlement request to the wallet server 10 by reading a barcode or a QR code (Registered Trademark) displayed on the user terminal 30 with a code reader or the like in the store or the like. In the settlement request that is transmitted from the settlement processing unit 315 to the wallet server 10, information (hereinafter, referred to as “settlement amount information”) indicating a settlement amount may be include or may not be included.

Subsequently, a controller 41 of the vehicle 40 transmits a settlement request including a settlement amount information to the wallet server 10 through the network NW. The controller 11 of the wallet server 10 that receives the settlement request from the vehicle 40 decreases the balance of electronic money in the wallet based on the settlement amount information included in the settlement request. That is, the controller 11 updates the wallet information 132 and the settlement information 133 stored in the storage unit 13 according to a decreased amount of the balance of electronic money in the wallet.

The settlement processing unit 315 can also perform settlement using payment means (for example, a bank account or a credit card) other than the balance of electronic money in the wallet. In this case, the settlement processing unit 315 transmits a settlement request for performing settlement with the bank account or the credit card using any one of a plurality of settlement means to the wallet server 10. The controller 11 of the wallet server 10 that receives the settlement request from the settlement processing unit 315 transmits settlement amount information included in the settlement request to the settlement service provider server 20.

In the storage unit 33, data of various screens that are displayed on the operation and display unit 35 by the display controller 311 is stored. In the storage unit 33, the user information 131, the wallet information 132, the settlement information 133, map information 134, and the like are continuously or temporarily stored as necessary.

The short-distance wireless communication unit 34 has a communication function, for example, conforming to a standard, such as Near field radio communication (NFC), Bluetooth (Registered Trademark) Low Energy (BLE), or Infrared Data Association (IrDA). The user terminal 30 performs short-distance wireless communication with the terminal in the store or the like through the short-distance wireless communication unit 34 when performing the electronic money payment.

The operation and display unit 35 is constituted of, for example, a touch panel display, and has an input function of receiving an operation with a finger of the user, a pen, or the like and a display function of displaying various kinds of information under the control of the display controller 311.

The positioning unit 36 receives radio waves from global positioning system (GPS) satellites to detect a position of the user terminal 30, for example. The position and a route of the user terminal 30 detected by the positioning unit 36 as a positional information acquisition unit of the user terminal 30 are stored as route information including a position in traveling information in the storage unit 33.

Vehicle

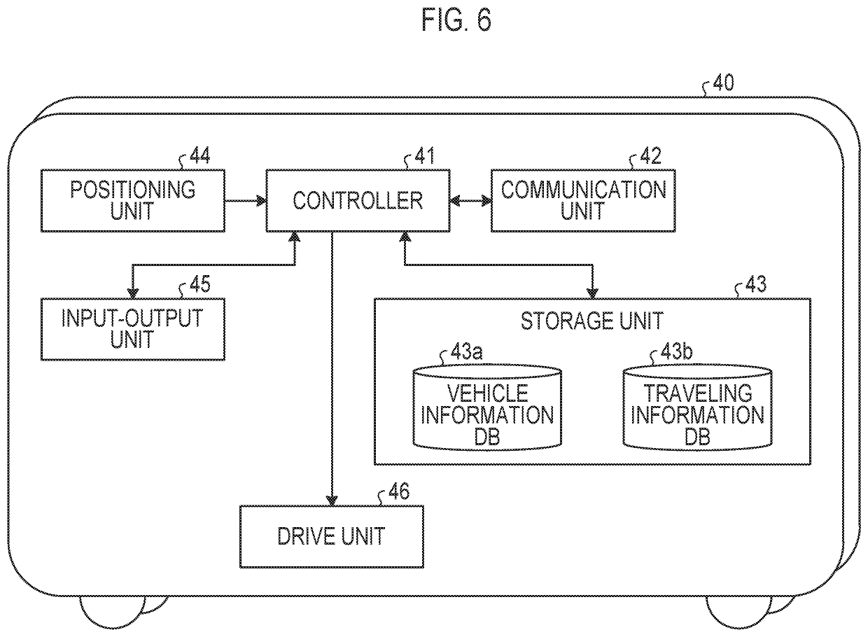

FIG. 6 is a block diagram schematically showing the configuration of the vehicle according to the embodiment of the present disclosure. The vehicle 40 as a moving object is a vehicle that travels with driving of a driver or an autonomous traveling vehicle configured to autonomously travel in compliance with a given traveling command. As shown in FIG. 6, the vehicle 40 includes the controller 41, a communication unit 42, a storage unit 43, a positioning unit 44, an input-output unit 45, and a drive unit 46.

The controller 41, the communication unit 42, and the storage unit 43 are physically the same as the controller 11, the communication unit 12, and the storage unit 13, respectively. The controller 41 integrally controls the operation of each component mounted in the vehicle 40. The communication unit 42 as a communication terminal of the vehicle 40 is constituted of, for example, a data communication module (DCM) that performs communication with the wallet server 10 by wireless communication through the network NW.

The storage unit 43 includes a vehicle information database 43a and a traveling information database 43b. In the vehicle information database 43a, various kinds of information including an SOC, a remaining amount of fuel, vehicle dimension information, and the like are stored in an updatable manner. In the traveling information database 43b, various kinds of information including traveling information regarding a traveling route are stored in an updatable manner. The traveling information is information measured and generated by the controller 41 based on information obtained from the positioning unit 44 and the drive unit 47.

The positioning unit 44 is physically the same as the positioning unit 36. The position and the route of the vehicle 40 detected by the positioning unit 44 as a positional information acquisition unit of the vehicle 40 are stored as positional information and route information in the traveling information in a searchable manner in the vehicle information database 43a. As a method of detecting the position of the vehicle 40, a method in which light detection and ranging or laser imaging detection and ranging (LiDAR) and a three-dimensional digital map are combined may be employed.

The input-output unit 45 is constituted of a touch panel display, a speaker microphone, and the like. The input-output unit 45 as an output unit is configured to display text, a figure, or the like on a screen of the touch panel display or output sound from the speaker microphone to notify the outside predetermined information under the control of the controller 41. The input-output unit 45 as an input unit is configured to input predetermined information to the controller 41 when the user or the like operates the touch panel display or makes sound toward the speaker microphone.

The vehicle 40 according to the embodiment includes the positioning unit 44 and the input-output unit 45 as separate functions, but may include an in-vehicle navigation system with a communication function that has the functions of both of the positioning unit 44 and the input-output unit 45, instead of the positioning unit 44 and the input-output unit 45.

The drive unit 47 is a drive unit that performs drive needed for traveling of the vehicle 40. Specifically, the vehicle 40 includes an engine as a drive source, and the engine is configured to generate electric power using an electric motor or the like through drive by combustion of fuel. The generated electric power charges a chargeable battery. In addition, the vehicle 40 includes a drive transmission mechanism that transmits drive power of the engine, drive wheels for traveling, and the like.

In the vehicle 40, a short-distance wireless communication unit having a communication function conforming to, for example, a standard, such as NFC, BLE, or IrDA, may be provided.

Area Information Management Server

The area information management server 50 is a server that manages information regarding a privilege set for each area. The area information management server 50 includes a controller, a communication unit, and a storage unit that are physically the same as the controller 11, the communication unit 12, and the storage unit 13, respectively. The area information management server 50 stores, for example, information regarding a privilege according to an area contribution degree, an expiration date of the privilege, and the like for each area. As the privilege, there is a discount of an article or service price, an article provided for free, or the like.

Distribution Information Creation Method

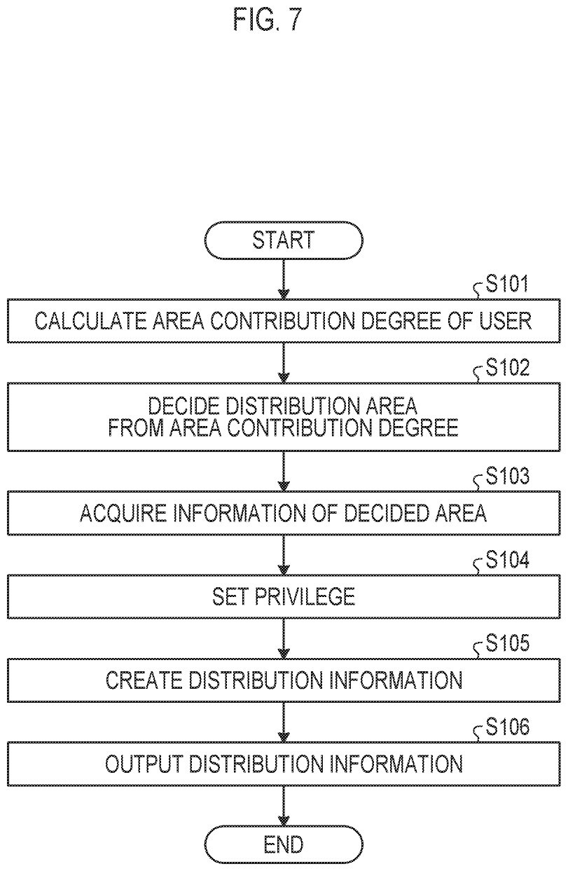

Next, a distribution information creation method regarding a privilege to area contribution by the wallet system 1 according to the embodiment configured as above will be described. FIG. 7 is a flowchart illustrating distribution information creation processing that is executed by the wallet server according to the embodiment of the present disclosure. The distribution information creation processing described below is creation processing of information that is distributed to a certain user in a purchase area based on a purchase history of the user, and is executed in the wallet server 10.

The controller 11 acquires an area contribution degree from an activity history of a target user to whom distribution information is transmitted (Step S101). Specifically, the area contribution degree calculation unit 111 calculates the area contribution degree using the number of visits of each area that the user visits and a purchase history in the area. The number of visits is calculated using the traveling history of the vehicle 40 or the positional information and the traveling history or the date of the positional information of the user terminal 30. In the number of visits, the number of times in which the area is set as a destination in the vehicle 40 may be included. The purchase history includes at least one of a purchase amount in the area and the number of stores where purchase is made in the area. The area contribution degree has a greater value as the number of visits is greater and the purchase amount is higher or the number of stores where purchase is made is greater. In addition, a stay time in the area may be included. The stay time is calculated using the traveling history of the vehicle 40 or the positional information of the user terminal 30.

The controller 11 decides an area, for which the distribution information is to be created, based on the area contribution degree (Step S102). The controller 11 decides, as an information distribution target area, an area to which the user has the area contribution degree equal to or greater than a threshold value (first distance) and which is separated at a distance set in advance from a residential area of the user. The first distance for area selection is set to a distance from the residential area of the user to an area that the user visits less frequently in daily life, for example, tens of km or more. In this case, setting can be performed excluding an area closely related to the user, such as a workplace or a hometown of the user. In this case, an area separated at a set distance from the residential area of the user and an area separated at tens of km or more from the workplace and the hometown of the user are selected.

The processing of Step S102 may be executed earlier than the processing of Step S101 to early decide an area for which the distribution information is to be created.

Thereafter, the controller 11 acquires the distribution information of the decided area (Step S103). In this case, the controller 11 acquires information regarding the decided area from the area information management server 50.

Thereafter, the privilege setting unit 112 sets a privilege based on the acquired area information and the area contribution degree (Step S104). In addition, when a campaign is conducted in specific settlement means, the privilege setting unit 112 also sets the campaign as a privilege. Examples of the privilege include a discount of a purchase price and presentation of an article. When the discount is set as the privilege, the privilege setting unit 112 makes a discount rate greater as the area contribution degree is higher.

Then, the distribution information creation unit 113 creates distribution information including a contribution area of the user and privilege information in the area (Step S105). In a case where the distribution information is created, the controller 11 outputs the distribution information to the user terminal 30 of the target user (Step S106). In the user terminal 30, an image based on the distribution information created in the wallet server 10 is displayed. When the privilege has a term, the distribution information creation unit 113 may perform setting for displaying the term or the number of days left until the term.

The distribution information creation unit 113 may acquire a personal schedule from the user terminal 30 of the target user or acquire an event schedule of the area from the area information management server 50 to distribute a privilege conforming to the schedule. For example, when the personal schedule is acquired, in a case where the user has a schedule to visit an area where the area contribution degree of the user is high or an area near the area, the distribution information creation unit 113 sets an effective privilege in the visit period. The distribution information creation unit 113 acquires an event schedule of an area where the area contribution degree of the information distribution target user is high, creates information regarding the content of an event to be held, a place, a period during which the event is held, and the like, and sets an effective privilege in the event period. When an event holding date approaches, the wallet server 10 may notify the user terminal 30 of the user who has a high area contribution degree in an event holding area that the event holding date approaches. The wallet server 10 notifies the user terminal 30, for example, seven days, three days, or the like before the holding date.

The controller 11 may transmit the distribution information to the user terminal 30 at a timing at which the distribution information is created or for example, when the user terminal 30 approaches the area, for which the distribution information is created, at a predetermined distance or less, may transmit the distribution information of the area to the user terminal 30. The “predetermined distance” used herein corresponds to a second distance, and is, for example, a distance that is tens of % with respect to a distance between a residential area of the user who carries the user terminal 30 and a privilege distribution area. Based on the positional information acquired from the user terminal 30 (or the vehicle 40), in a case where the user approaches the privilege distribution area at a distance that is tens of % with respect to the distance between the residential area of the user and the privilege distribution area, the controller 11 transmits distribution information of the privilege distribution area to the user terminal 30.

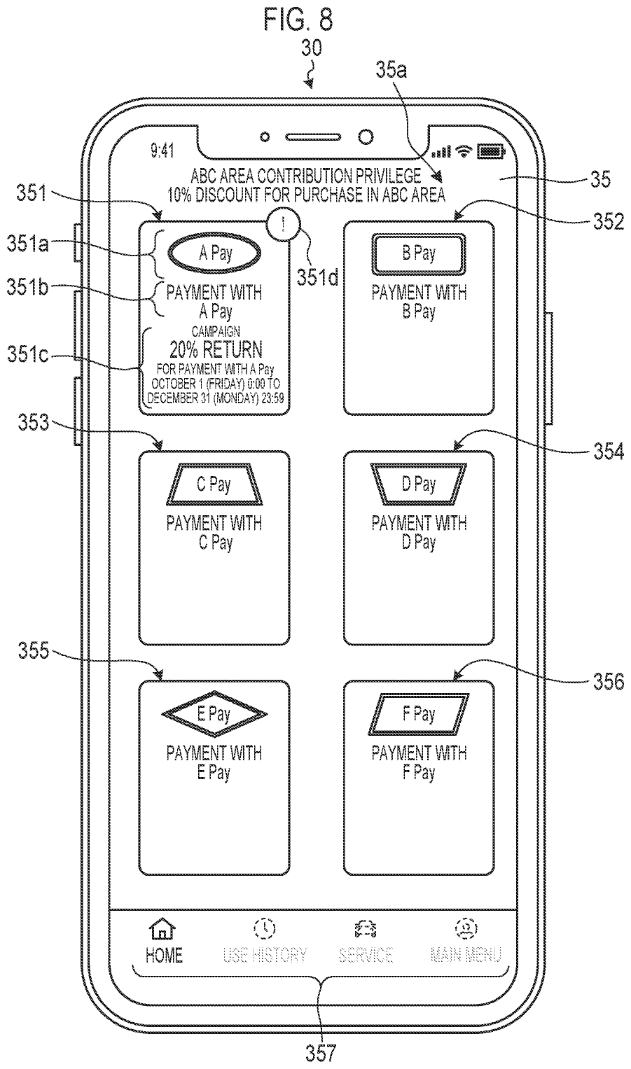

In a case where the user terminal 30 receives the distribution information, the display controller 311 displays the distribution information on the operation and display unit 35. FIG. 8 is a diagram showing an example where the distribution information is displayed on the operation and display unit of the user terminal in the wallet system according to the embodiment. On the user terminal 30 that receives the distribution information, a guidance screen 35a shown in FIG. 8 is displayed. The display controller 311 displays, on the guidance screen 35a, a user contribution area and privilege information of the area created based on the activity history of the user. For example, a contribution area and a privilege are displayed at an upper end of the guidance screen 35a, and settlement means is displayed therebelow. In FIG. 8, the guidance screen 35a in a case where “A Pay”, “B Pay”, “C Pay”, “D Pay”, “E Pay”, and “F Pay” are registered as settlement methods is displayed as an example. On the guidance screen 35a, specifically, settlement icons 351 to 356 displayed in a list and a menu switching area 357 are included. The guidance screen 35a is a screen that is displayed, for example, when an application of a wallet is opened.

The settlement icons 351 to 356 are areas that display the settlement methods, and receive requests for performing settlement using the displayed settlement methods. The display controller 311 displays, in the settlement icon 351, a settlement name 351a indicating a name of a settlement method usable in the user terminal 30, a settlement phrase 351b specifying the effect that settlement by the settlement method is performed, a settlement information area 351c where additional information regarding each settlement method is displayed, and a notification icon 351d that is additional information for notifying of a campaign. In FIG. 8, in A Pay, a campaign different from other Pays is conducted, and a privilege and the notification icon 351d are displayed.

Specifically, in the settlement icon 351, a mark (logo mark, acceptance mark, or the like) including the name “A Pay” is displayed as the settlement name 351a, characters “Payment with A Pay” are displayed as the settlement phrase 351b, information regarding a campaign as a service regarding “A Pay” is displayed as the settlement information area 351c, and the notification icon 351d for making the user recognize the campaign is displayed. Even in the settlement icons 352 to 356, the name of the settlement method, the mark indicating the settlement method, the settlement phrase, the additional information, the icon, and the like are displayed like the settlement icon 351 functionally.

Here, when the user visits the area where the distribution information is distributed, in FIG. 8, in a case where the settlement icon 351 indicating the “A Pay” is selected by the user, the display controller 311 displays an electronic settlement screen prepared in advance. In a case where an input to confirm settlement is received from the user on the electronic settlement screen, the controller 11 transmits a settlement request for performing settlement to the wallet server 10. The controller 11 of the wallet server 10 that receives the settlement request from the settlement processing unit 315 transmits settlement amount information included in the settlement request to the settlement service provider server 20. In this case, a set privilege (in FIG. 8, discount and return point) is reflected.

The user can reserve a store, to which the privilege is set, from the distribution information displayed on the user terminal 30 by way of the wallet server 10. In addition, the user can also perform advance settlement of the reserved store through the wallet server 10 and the settlement service provider server 20.

In the above-described embodiment, the wallet server 10 transmits the distribution information of the area at the predetermined distance from the residential area of the user including the privilege set according to the contribution degree to the area to the user terminal 30 based on the activity history of the user and displays the distribution information on the user terminal 30. According to the embodiment, the distribution information is displayed on the user terminal 30 to promote a revisit of the user to the area or purchase of an article or a service of the area, whereby it is possible to support revitalization of the area.

Recording Medium

In the embodiment, a program that can execute a processing method by the wallet server 10 or the user terminal 30 can be recorded on a recording medium that is readable by a computer or other machines or apparatuses (hereinafter, referred to as a computer or the like). The program on the recording medium is read to and executed on the computer or the like, whereby the computer or the like functions as the controller of the wallet server 10 or the user terminal 30. Here, the recording medium that is readable by the computer or the like refers to a non-transitory recording medium on which information, such as data or programs, can be accumulated by an electrical, magnetic, optical, mechanical, or chemical action and can be read through the computer or the like. Among such recording mediums, examples of recording mediums that are removable from the computer or the like include a flexible disk, a magneto-optical disk, a CD-ROM, a CD-R/W, a digital versatile disk (DVD), a BD, a DAT, a magnetic tape, and a memory card, such as a flash memory. Examples of recording mediums that are fixed in the computer or the like include a hard disk and a ROM. In addition, an SSD is available as a recording medium that is removable from the computer or the like or as a recording medium that is fixed in the computer or the like.

### Other Embodiments

In the wallet system 1 according to the embodiment, a “unit” can be replaced with a “circuit” or the like. For example, the communication unit can be replaced with a communication circuit.

The program that is executed by the wallet server 10 or the user terminal 30 according to the embodiment may be provided by storing the program on a computer connected to a network, such as the Internet, and downloading the program by way of the network.

In the wallet server 10 according to the embodiment, the visit area of the user may be decided with a movement history of the user terminal 30 measured in the user terminal 30 or the like, that is, a movement history of the user by means, such as walking, other than the vehicle 40 or a traveling route of the vehicle 40 as the activity history of the user in addition to the purchase history. When the traveling route of the vehicle 40 is used as the activity history of the user, the user terminal 30 may not have the positioning unit 36.

Other effects or modification examples can be easily derived by those skilled in the art. Broader aspects of the present disclosure are not limited to specific details and representative embodiments shown and described above. Accordingly, various alterations may be made without departing from the spirit or scope of the general inventive concept defined by the appended claims and equivalent thereof.

What is claimed is:

1. An information processing apparatus comprising a processor having hardware,
wherein the processor is configured to
calculate an area contribution degree in a visit area at a first distance or more from a residential area of a user based on an activity history of the user,
create distribution information including a privilege according to the area contribution degree, and
display the distribution information on a user terminal of the user.

2. The information processing apparatus according to claim 1, wherein the processor is configured to calculate the area contribution degree using the number of visits to the visit area and a purchase history in the visit area.

3. The information processing apparatus according to claim 1, wherein the processor is configured to calculate the area contribution degree using the number of visits to the visit area and a purchase history in the visit area.

4. The information processing apparatus according to claim 3, wherein the purchase history includes at least one of a purchase amount in the visit area and the number of stores where purchase is made in the visit area.

5. The information processing apparatus according to claim 3, wherein the processor is configured to calculate the area contribution degree using the number of visits to the visit area, the purchase history in the visit area, and a stay time of the visit area.

6. The information processing apparatus according to claim 1, wherein the processor is configured to acquire a personal schedule of the user and set a privilege to be applied in a period conforming to the personal schedule.

7. The information processing apparatus according to claim 1, wherein the processor is configured to acquire an event schedule in the visit area and create distribution information including information of an event and a privilege to be applied in a period confirming to the event schedule.

8. The information processing apparatus according to claim 1, wherein the processor is configured to output the distribution information in a case where the user approaches the visit area at a second distance or less.

9. The information processing apparatus according to claim 1, wherein the processor is configured to, for a plurality of settlement means set in the user terminal, set a privilege of at least a part of the settlement means to a privilege different from other settlement means.

10. An information processing program causing a processor having hardware to execute
calculating an area contribution degree in a visit area at a first distance or more from a residential area of a user based on an activity history of the user,
creating distribution information including a privilege according to the area contribution degree, and
displaying the distribution information on a user terminal of the user.

11. The information processing program according to claim 10, causing the processor to execute calculating the area contribution degree using the number of visits to the visit area and a purchase history in the visit area.

12. The information processing program according to claim 10, causing the processor to execute calculating the area contribution degree using the number of visits to the visit area and a purchase history in the visit area.

13. The information processing program according to claim 12, wherein the purchase history includes at least one of a purchase amount in the visit area and the number of stores where purchase is made in the visit area.

14. The information processing program according to claim 12, causing the processor to execute calculating the area contribution degree using the number of visits to the visit area, the purchase history in the visit area, and a stay time of the visit area.

15. The information processing program according to claim 10, causing the processor to execute acquiring a personal schedule of the user and setting a privilege to be applied in a period conforming to the personal schedule.

16. The information processing program according to claim 10, causing the processor to execute acquiring an event schedule in the visit area and creating distribution information including information of an event and a privilege to be applied in a period confirming to the event schedule.

17. The information processing program according to claim 10, causing the processor to execute outputting the distribution information in a case where the user approaches the visit area at a second distance or less.

18. The information processing program according to claim 10, causing the processor to execute, for a plurality of settlement means set in the user terminal, setting a privilege of at least a part of the settlement means to a privilege different from other settlement means.

19. An information processing system comprising:
a terminal including a first processor having hardware, and a display; and
an information processing apparatus including a second processor having hardware, the second processor being configured to calculate an area contribution degree in a visit area at a first distance or more from a residential area of a user of the terminal based on an activity history of the user, create distribution information including a privilege according to the area contribution degree, and display the distribution information on the terminal.

20. The information processing system according to claim 19, wherein the second processor is configured to output the distribution information to the terminal in a case where the user approaches the visit area at a second distance or less.
